(19) United States
(12) Patent Application Publication
(10) Pub. No.: US 2014/0215371 A1
(43) Pub. Date: Jul. 31, 2014

(54) DATA MANAGING METHOD AND ELECTRONIC DEVICE THEREOF

(71) Applicant: SAMSUNG ELECTRONICS CO., LTD, Gyeonggi-do (KR)

(72) Inventor: Zhiqiang Liu, Guangzhou City (CN)

(73) Assignee: SAMSUNG ELECTRONICS CO., LTD, Gyeonggi-do (KR)

(21) Appl. No.: 14/168,960

(22) Filed: Jan. 30, 2014

(30) Foreign Application Priority Data
Jan. 30, 2013 (CN) 201310037364.2

(51) Int. Cl. G06F 3/0486; G06F 3/0481

(52) U.S. Cl. CPC G06F 3/0486; G06F 3/04817
USPC 715/769

(57) ABSTRACT

A method for operating portable terminal comprises displaying a virtual container for receiving the file items to be operated on the user interface of the portable terminal, when a user command for adding a file and/or a folder under any folder is detected, obtaining a path information of the file and/or folder, and inserting a file link item containing the name and path information of the file and/or folder into a list of the virtual container content, when a user command for transmitting the files in the virtual container is detected, transmitting the file and/or folder corresponding to the respective file link items in the content list to a location designated by a user.

### CROSS-REFERENCE TO RELATED APPLICATION(S) AND CLAIM OF PRIORITY

The present application is related to and claims priority under 35 U.S.C. §119(a) to a Chinese Patent Application No. 201310037364.2 filed in the State Intellectual Property Office on Jan. 30, 2013, the contents of which are herein incorporated by reference.

### TECHNICAL FIELD

The present disclosure relates to data managing method and electronic device thereof.

### BACKGROUND

When a user desires to batch share text files, pictures, audio and/or video files and the like stored on different folders or paths through a wireless network, such as Bluetooth, and other communication means on a conventional portable terminal, he may only upload the selected files separately under the respective folders involved, which is rather inconvenient.

As shown in FIG. 1, the user browses the files under a folder 1 (e.g. the picture folder shown in FIG. 2) and selects one or more files to be uploaded. Whereby, the user must upload the files under the selected folder 1 to the Internet or other terminals according to a selected transmission method among the operation options as shown in FIG. 2. Similarly, the user has to browse a folder 2 and select one or more files to be uploaded, then he upload the files selected under the folder 2 again, according to a selected transmission method. Similarly, the user has to browse a folder 3 and select one or more files to be uploaded, then he upload the files selected under the folder 3 again, according to a selected transmission method. When the user selects and uploads the files under many different folders by using the above upload method, it will be rather inconvenient.

### SUMMARY

To address the above-discussed deficiencies, it is a primary object to provide a method and apparatus for operating portable terminal by recording files selected by a user from different folders and batch processing the selected files (e.g. transmitting the files) so as to facilitate the user operation.

According to one aspect of the present disclosure, there is provided a method for operating the portable terminal, the method including: displaying a virtual container for receiving a file items to be operated on the user interface of the portable terminal; when a user command for adding a file and/or a folder under any folder is detected, obtaining a path information of the file and/or folder, and inserting the file link item containing the name and path information of the file and/or folder into a virtual container content list; when a user command for transmitting the files in the virtual container is detected, transmitting the file and/or folder corresponding to the respective file link items in the virtual container content list to a location designated by a user.

In certain embodiments, the virtual container is a floating window or a homepage icon, and is displayed on the user interface of any folder.

In certain embodiments, the user command for adding file and/or folder under any folder includes: touching and dragging an icon representing the file and/or folder to the virtual container and then releasing the touch.

In certain embodiments, the method further comprising: when a user command for copying a file and/or a folder under any folder is detected, obtaining the path information of the file and/or folder, and inserting the file link item containing the name and content of the file and/or folder into the virtual container content list.

In certain embodiments, the method further comprising: when a user command for opening the virtual container is detected, displaying the icon of the file and/or folder for representing each file link item in the virtual container content list.

In certain embodiments, the method further comprising: when it is detected that the user determines to perform a predetermined operation on one or more icons in the virtual container window, searching for the file link item of the file and/or folder represented by the one or more icons from the virtual container content list, and performing the predetermined operation on the file and/or folder corresponding to the respective file link items, the predetermined operation referring to one of the operations including sharing, copying, moving and deleting files as well as the default operations carried out based on the file types.

In certain embodiments, a file type information is also stored in the file link item, and when a user command for opening the virtual container is detected, displaying in the virtual container window the icons of the file and/or folder for representing each file link item in the virtual container content list in categories based on the file types.

In certain embodiments, when detecting the user command for opening the virtual container, also displaying a menu item for selecting the operations performed on the file in a predetermined position in the virtual container window, and when detecting the user determines to perform the operations on one or more icons in the virtual container window, also receiving the user selection for the operation performed on the file and/or folder represented by the one or more icons, searching for the file link item of the file and/or folder represented by the one or more icons from the virtual container content list, and performing the operation selected by the user on the file and/or folder corresponding to the searched respective file link items.

In certain embodiments, when receiving the user selection for selecting one or more icons in the virtual container window and performing the file sharing operation on the file and/or folder represented by the icons, a share operation is performed on the file and/or folder corresponding to the searched respective file link items according to the predetermined sharing method; when receiving the user selection for selecting one or more icons in the virtual container window and performing the file copying operation on the file and/or folder represented by the icons, copying the file and/or folder corresponding to the searched respective file link items to the position designated by the user; when receiving the user selection for selecting one or more icons in the virtual container window and performing the file moving operation on the file and/or folder represented by the icons, moving the file and/or folder corresponding to the searched respective file link items to the position designated by the user; when receiving the user selection for selecting one or more icons in the virtual container window and performing the file deleting operation on the file and/or folder represented by the icons, deleting the file and/or folder corresponding to the searched respective file link items.

In certain embodiments, the method further comprises when a user command for removing a designated icon in the virtual container window is detected, deleting the file link items of the file and/or folder represented by the icons from the virtual container content list.

According to another aspect of the present disclosure, an apparatus for operating the portable terminal includes a first module for displaying a virtual container for receiving a file items to be operated on the user interface of the portable terminal, a second module for obtaining a path information of the file and/or folder, and inserting the file link item containing the name and path information of the file and/or folder into a virtual container content list when a user command for adding the file and/or a folder under any folder is detected, a third module for transmitting the file and/or folder corresponding to the respective file link items in the virtual container content list to a location designated by a user when a user command for transmitting the files in the virtual container is detected.

In certain embodiments, the virtual container is a floating window or a homepage icon, and is displayed on the user interface of any folder.

In certain embodiments, the user command for adding the file and/or folder under any folder includes touching and dragging an icon representing the file and/or folder to the virtual container and then releasing the touch.

In certain embodiments, the apparatus further comprises a seventh module for inserting the file link item containing the name and content of a file and/or folder into the virtual container content list when a user command for copying the file and/or a folder under any folder is detected.

In certain embodiments, the apparatus further comprises a fourth module for displaying an icons of the file and/or folder for representing each file link item in the virtual container content list in the virtual container window when a user command for opening the virtual container is detected.

In certain embodiments, the apparatus further comprises a fifth module for searching for the file link item of the file and/or folder represented by the one or more icons from the virtual container content list, and performing a predetermined operation on the file and/or folder corresponding to the respective file link items when detecting the user determines to perform the predetermined operation on the one or more icons in the virtual container window, wherein, the predetermined operation referring to one of the operations including sharing, copying, moving and deleting files as well as the default operations carried out based on the file types.

In certain embodiments, a file type information is also stored in the file link item, and when a user command for opening the virtual container is detected by the fourth module, the fourth module displaying in the virtual container window the icons of the file and/or folder for representing each file link item in the virtual container content list in categories based on the file types.

In certain embodiments, when the fourth module detecting the user command for opening the virtual container, the fourth module also displaying a menu item for selecting the operations performed on the file in a predetermined position in the virtual container window, and when the fifth module detecting the user determines to perform the operations on the one or more icons in the virtual container window, the fifth module further receiving the user selection for the operation performed on the file and/or folder represented by the one or more icons, searching for the file link item of the file and/or folder represented by the one or more icons from the virtual container content list, and performing the operation selected by the user on the file and/or folder corresponding to the searched respective file link items.

In certain embodiments, when the fifth module receiving the user selection for selecting one or more icons in the virtual container window and performing the file sharing operation on the file and/or folder represented by the icons, the fifth module performing a share operation on the file and/or folder corresponding to the searched respective file link items according to the predetermined sharing method; when the fifth module receiving the user selection for selecting one or more icons in the virtual container window and performing the file copying operation on the file and/or folder represented by the icons, the fifth module copying the file and/or folder corresponding to the searched respective file link items to the position designated by the user; when the fifth module receiving the user selection for selecting one or more icons in the virtual container window and performing the file moving operation on the file and/or folder represented by the icons, the fifth module moving the file and/or folder corresponding to the searched respective file link items to the position designated by the user; when the fifth module receiving the user selection for selecting one or more icons in the virtual container window and performing the file deleting operation on the file and/or folder represented by the icons, the fifth module deleting the file and/or folder corresponding to the searched respective file link items.

In certain embodiments, the apparatus further comprising: a sixth module for deleting the file link items of the file and/or folder represented by a designated icons from the virtual container content list when a user command for removing the designated icon in the virtual container window is detected.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

These and other purposes and features of the disclosure will become apparent and more readily appreciated from the following description, taken in conjunction with the accompanying drawings in which:

FIG. 1 is a diagram illustrating the conventional method for operating the portable terminal;

FIG. 2 is a diagram illustrating the user interface for selecting the files in the folder and the transmission method according to the prior art;

FIG. 3 is a diagram illustrating the method for operating the portable terminal according to the exemplary embodiment of the present disclosure;

FIGS. 4-7 are the diagrams illustrating user interface of the method for operating the portable terminal according to the exemplary embodiment of the present disclosure;

FIG. 8 is a flowchart illustrating the method for operating the portable terminal according to the exemplary embodiment of the present disclosure.

### DETAILED DESCRIPTION

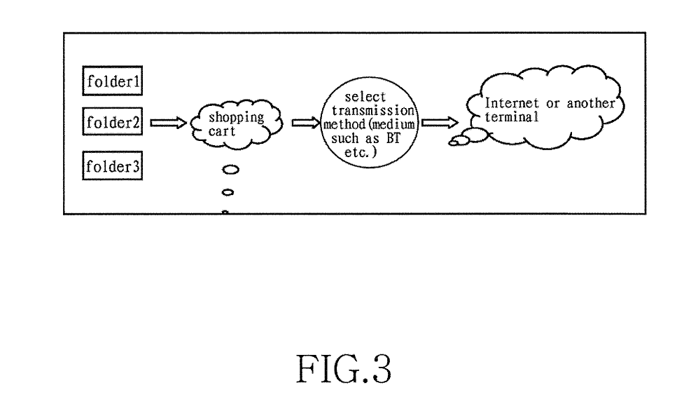

FIGS. 3 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Embodiments of the present disclosure will be described in detail below by referring to the accompany drawings.

The method for operating the portable terminal of the present disclosure may be realized by providing the portable terminal with a software module for realizing the respective steps disclosed herein, and said method may also be realized by the any combination of the software, the hardware and the firmware. According to the requirements of the embodiments, said respective steps may be divided into more steps, also, two or more steps or part of the operations in said steps may be combined into new steps so as to achieve the purpose of the present disclosure.

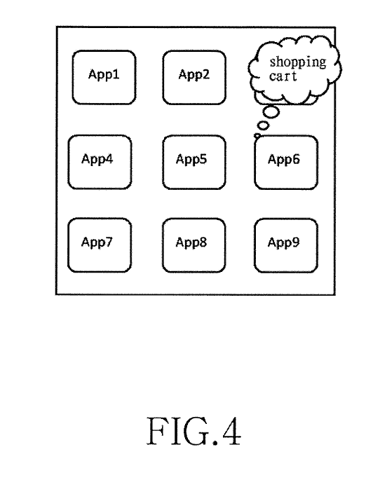

FIG. 3 illustrates the method for operating the portable terminal according to the embodiments of the present disclosure. FIGS. 4-7 illustrate user interface of the method for operating the portable terminal according to the embodiments of the present disclosure.

According to the embodiments of the present disclosure, a file “shopping cart”, that is, a virtual container for performing operation on the file and/or folder selected by the user, is provided in the portable terminal. Said virtual container may be a floating window or a homepage icon, but is not limited thereto, and displayed on the user interface of any folder. In addition, the portable terminal maintains the virtual container content list for recording the file information in the virtual container, said virtual container content list includes file link items, each file link item includes the file name and/or folder name and the path information thereof. The virtual container content list is blank at the beginning.

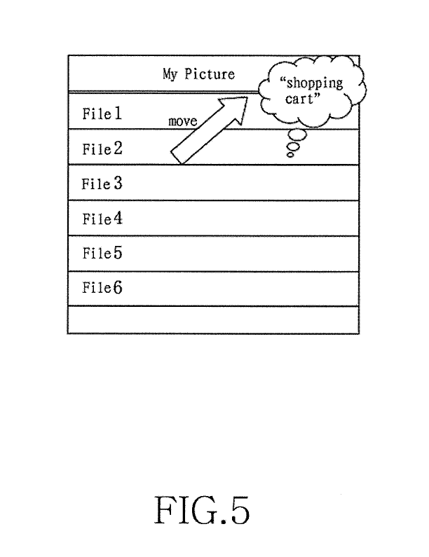

Referring to FIG. 3, when the user successively browses the files in folder 1, folder 2 and folder 3, the files and/or folders for batch operation (e.g. uploading) can be selected from the respective folders, also, said selected file and/or folder can be added to the virtual container (“shopping cart”), for example, by touching and dragging the icon representing said file and/or folder to said virtual container (“shopping cart”) and then releasing the touch. FIG. 4 illustrates the user interface displaying the “shopping cart” in the form of a floating window. FIG. 5 illustrates the user interface adding the file 2 to the “shopping cart” under a folder (e.g., “My Picture”).

When a user command for adding a file and/or a folder under any folder is detected by the portable terminal, the portable terminal obtains the path information of said file and/or folder, and inserts the file link item containing the name and path information of said file and/or folder into the virtual container content list. Accordingly, when the user adds the file and/or folder from different folders, the virtual container content list records the information of the file and/or folder from different folders.

According to one alternative embodiment of the present disclosure, the user can actually copy the selected file and/or folder (rather than the link thereof) to said virtual container by using specific command or action (e.g. the “copy” command). In this case, when a user command for copying a file and/or a folder under any folder is detected, the portable terminal will insert the file link item containing the name and content of said file and/or folder into the virtual container content list.

When a user command for opening the shopping cart is detected by the portable terminal, the icons of the file and/or folder for representing each file link item in the virtual container content list are displayed in the shopping cart window of the portable terminal.

When a user command for transmitting the files in the virtual container is detected by the portable terminal, the portable terminal transmits the file and/or folder corresponding to the respective file link items in the virtual container content list to a location designated by the user. The respective files can be transmitted by means of E-mail, Bluetooth and MMS, etc. according to the user's choice.

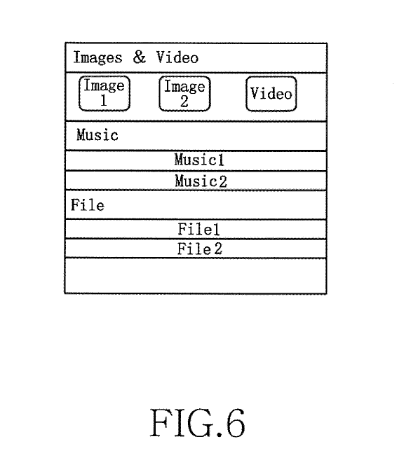

According to the preferred embodiment of the present disclosure, the portable terminal also stores the file type information in each file link item, and when a user command for opening the shopping cart is detected, the icons of the file and/or folder for representing each file link item in the virtual container content list are displayed in the shopping cart window in categories based on the file types. FIG. 6 illustrates a user interface, wherein, when a user command for opening the shopping cart is detected, the portable terminal displays in the shopping cart window the icons of the file and/or folder for representing each file link item in the virtual container content list in categories according to the file types. Wherein, the pictures (image1, image2), the video, the music (Music1, Music2) and the text (File1, File2) are displayed in categories of “Picture and Video”, “Music” and “Text”. Wherein, all the folders in the shopping cart can be displayed in the “Folder” category (not illustrated in FIG. 6).

According to the preferred embodiment of the present disclosure, when it is detected that the user determines to perform operations on one or more icons in the shopping cart window, the portable terminal searches for the file link item of the file and/or folder represented by said one or more icons from the virtual container content list, and performs predetermined operation on the file and/or folder corresponding to the respective file link items, said predetermined operation referring to one of the operations including sharing, copying, moving and deleting files as well as the default operations carried out based on the file types. According to one embodiment of the present disclosure, as shown in FIG. 3, the portable terminal uploads all or part of the files in the shopping cart to the Internet or other terminal device through bittorrent.

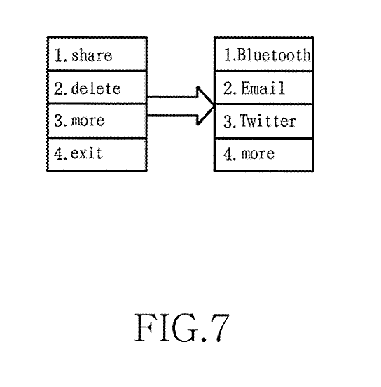

According to a preferred embodiment of the present disclosure, when a user command for opening the shopping cart is detected, the portable terminal also displays the menu item for selecting the operations performed on the files in the predetermined position in the shopping cart window; when it is deceted that the user determines to perform operations on one or more icons in the shopping cart window, the portable terminal also receives the user selection for operations performed on the file represented by one or more icons, searches for the file link item of the file and/or folder represented by said one or more icons from the virtual container content list, and performs the operation selected by the user on the file and/or folder corresponding to the respective file link items. Said operations performed on the file and/or folder can be one of the operations including sharing, copying, moving and deleting files as well as the default operations carried out based on the file types, but are not limited thereto. Said default operations carried out based on the file types referring to the operations automatically initiated when the file icon is double-clicked. For example, when the video and audio files is double-clicked, the default operation is “play”; when the text file is double clicked, said default operation is “open file”; when the folder is double clicked, said default operation is “open folder”. FIG. 7 illustrates the operation options including sharing and deleting files, etc.

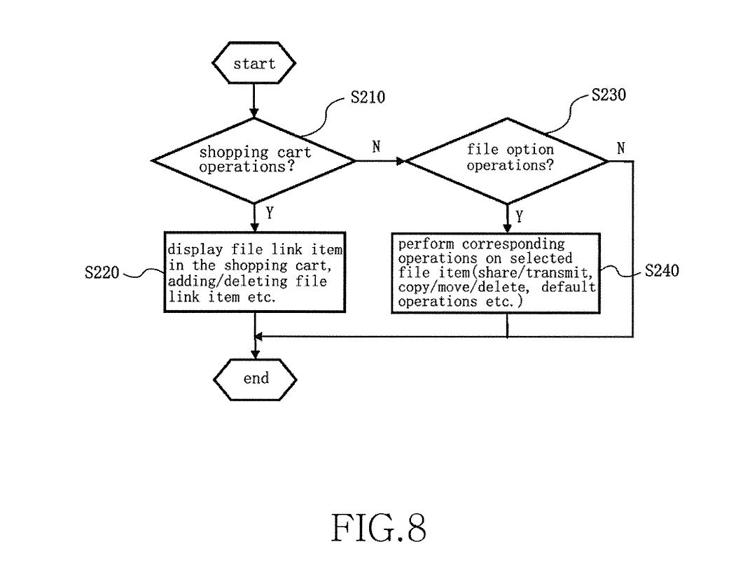

Hereinafter, processing on the method for operating the portable terminal will be described in detail with reference to FIG. 8.

As mentioned above, the portable terminal displays a virtual container (i.e. the “shopping cart”) for receiving the file items to be operated on the user interface thereof.

Referring to FIG. 8, if the portable terminal detects the user operations on said shopping cart in step S210, the portable terminal executes step S220. Said operations on the shopping cart in step S210 includes displaying the shopping cart, as well as adding and removing the files and so on, but not limited thereto.

In step S220, the portable terminal performs operations on the shopping cart according to the type of user operation on the shopping cart.

In step S210, when a user command for adding a file and/or a folder under any folder is detected, the portable terminal obtains the path information of said file and/or folder, and inserts the file link item containing the name and path information of said file and/or folder into the virtual container content list in step S220. Said user command for adding a file and/or a folder under any folder can include touching and dragging the icon representing said file and/or folder to said shopping cart and then releasing the touch, but not limited thereto.

According to the preferred embodiment of the present disclosure, in step S210, when a user command for copying a file and/or a folder under any folder is detected (e.g. the “copy” button), the portable terminal will insert the file link item containing the name and content of said file and/or folder into the virtual container content list in step S220.

In step S210, when a user command for opening the shopping cart is detected, the portable terminal displays the icons of the file and/or folder for representing each file link item in the virtual container content list in the shopping cart window in step S220. According to the preferred embodiment of the present disclosure, the portable terminal also stores the file type information in said file link item, and when a user command for opening the shopping cart is detected in step S210, the portable terminal displays in the shopping cart window the icons of the file and/or folder for representing each file link item in the virtual container content list in categories based on the file types in step S220.

According to the preferred embodiment of the present disclosure, in step S210, when a user command for removing the designated icon in the shopping cart window is detected (e.g., clicking the delete button), the portable terminal deletes the file link items of the file and/or folder represented by said icons from the virtual container content list in step S220.

On the other hand, in step S210, if a user operation on the shopping cart is not detected by the portable terminal, the portable terminal determines whether the user indicates to perform operations on the file and/or folder represented by the icons in the shopping cart window in step S230. If the portable terminal detects the user indicates to perform operations on the icons in the shopping cart window in step S230, the portable terminal executes step S240.

According to an embodiment of the present disclosure, in step S230, when a user command for transmitting the files in the virtual container is detected, the portable terminal transmits the file and/or folder corresponding to the respective file link items in the virtual container content list to a location designated by the user in step S240. The files in the folder to be transmitted can be packaged first for transmission, or all the files under the folder to be transmitted can be transmitted directly.

According to yet another embodiment of the present disclosure, in step S230, when it is detected that the user determines to perform operations on one or more icons in the shopping cart window, the portable terminal searches for the file link item of the file and/or folder represented by said one or more icons from the virtual container content list, and performs predetermined operation on the file and/or folder corresponding to the respective file link items in step S240, said predetermined operation referring to one of the operations including sharing, copying, moving and deleting files as well as the default operations carried out based on the file types.

According to one preferred embodiment of the present disclosure, when a user command for opening the shopping cart is detected, the menu item for selecting the operations performed on the files is also displayed in the predetermined position in the shopping cart window. In this scenario, in step S230, when it is detected that the user determines to perform the operation on one or more icons in the shopping cart window, the portable terminal also receives the user selection for the operation performed on the file and/or folder represented by one or more icons, and, in step S240, the portable terminal searches for the file link item of the file and/or folder represented by said one or more icons from the virtual container content list, and performs the operation selected by the user on the file and/or folder corresponding to the respective searched file link items. Said operations on the file can be one of the operations including sharing, copying, moving and deleting files as well as the default operations carried out based on the file types, but not limited thereto.

In step S230, when the user selection for selecting one or more icons in the shopping cart window and performing the file sharing operation on the file and/or folder represented by said icons is received, the portable terminal will perform share operation on the file and/or folder corresponding to the searched respective file link items according to the predetermined sharing method in step S240.

In step S230, when the user selection for selecting one or more icons in the shopping cart window and performing the file copying operation on the file and/or folder represented by said icons is received, the portable terminal copies the file and/or folder corresponding to the searched respective file link items to the position designated by the user in step S240.

In step S230, when the user selection for selecting one or more icons in the shopping cart window and performing the file moving operation on the file and/or folder represented by said icons is received, the portable terminal moves the file and/or folder corresponding to the searched respective file link items to the position designated by the user in step S240.

In step S230, when the user selection for selecting one or more icons in the shopping cart window and performing the file deleting operation on the file and/or folder represented by said icons is received, the portable terminal deletes the file and/or folder corresponding to the searched respective file link items in step S240.

In step S230, when the user selection for selecting one or more icons in the shopping cart window and performing the default operation on the file and/or folder represented by said icons is received, the portable terminal performs the default operations according to the file types on the file and/or folder corresponding to the searched respective file link items based on the file types in step S240.

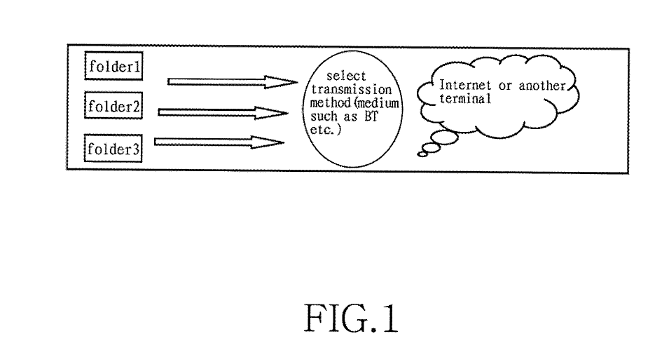

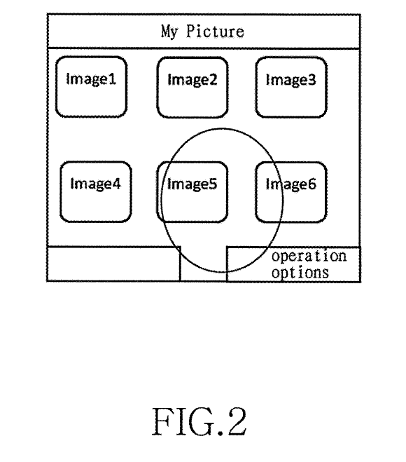

Based on the above description of the embodiments of the present disclosure with reference to FIGS. 1-8, it can be seen that, according to the method for operating the portable terminal of the present disclosure, the batch operations can be performed on multiple files and/or folders stored on different paths by providing a shopping cart with respect to the files and recording the information on the files and/or folders in the shopping cart, thus facilitating the user operation.

The present disclosure also provides an apparatus for carrying out the method for operating the portable terminal.

While the present disclosure has been shown and described with reference to embodiments thereof, it will be understood by those of ordinary skilled in the art that various changes in form and details may be made therein without departing from the spirit and scope of the present disclosure as defined by the following claims.

What is claimed is:

1. A method for managing data in an electronic device, the method comprising:
displaying a virtual container corresponding to a folder generated for receiving at least one data;
when a user command for adding the at least one data under the folder of the virtual container is detected, obtaining a name and a path of the at least one data, and inserting a file link item containing the name and the path of the at least one data into a content list of the virtual container;
when a user command associated with the file link item of the virtual container is detected, performing at least one function of the user command.

2. The method of claim 1, wherein the virtual container is a floating window or icon, which is displayed over a user interface of any folder.

3. The method of claim 2, wherein the user command for adding the at least one data under the folder of the virtual container comprises:
touching and dragging an icon representing the at least one data and then releasing the touch over the folder of the virtual container.

4. The method of claim 1, further comprising:
when a user command for copying the at least one data under the folder of the virtual container is detected, obtaining the path of the at least one data, and inserting the file link item containing the name and content of the at least one data into the content list of the virtual container.

5. The method of claim 4, further comprising:
when a user command for opening the virtual container is detected, displaying at least one icon of the at least one data for representing each file link item within the virtual container.

6. The method of claim 5, further comprising:
when it is detected that the user performs an operation on at least one icon in the virtual container, searching for the file link item of the at least one data represented by each icon from the virtual container content list, and performing the operation on the at least one data corresponding to the respective file link item, wherein the operation refers to at least one of sharing, copying, moving, transmitting and deleting files and default operations carried out based on file types.

7. The method of claim 5, wherein a file type information is further stored in the file link item, and
when a user command for opening the virtual container is detected, displaying on a virtual container window each icon of the at least one data for representing respective file link item in the content list, according to categories of the file types.

8. The method of claim 7, further comprising:
wherein when a user command for opening the virtual container is detected, displaying the menu item for selecting the operations performed on the file in the predetermined position in the virtual container window, and
when it is detected that the user performs the operations on the at least one icon in the virtual container window, receiving the user selection for the operation performed on the at least one data represented by the one or more icons, searching for the file link item of the file and/or folder represented by the one or more icons from the content list, and performing the operation selected by the user on the at least one data corresponding to the searched respective file link items.

9. The method of claim 8, wherein
when the user selection for selecting at least one icon in the virtual container window and performing the file sharing operation on the at least one data represented by the icons is received, a share operation is performed on the at least one data corresponding to the searched respective file link items according to the sharing method,
when the user selection for selecting at least one icon in the virtual container window and performing the file copying operation on the at least one data represented by the icons is received, copying the at least one data corresponding to the searched respective file link items to the position designated by the user;
when the user selection for selecting at least one icon in the virtual container window and performing the file moving operation on the at least one data represented by the icons is received, moving the at least one data corresponding to the searched respective file link items to the position designated by the user;
when the user selection for selecting at least one icon in the virtual container window and performing the file deleting operation on the at least one data represented by the icons is received, deleting the at least one data corresponding to the searched respective file link items.

10. The method of claim 6, further comprising:
when a user command for removing a designated icon in the virtual container window is detected, deleting the file link items of the at least one data represented by the designated icon from the content list.

11. An electronic device comprising:
a first module configured to display a virtual container for receiving a file items to be operated on the user interface of the portable terminal;
a second module configured to obtain a path of at least one data, and inserting the file link item containing a name and a path of the at least one data into a content list of the virtual container when a user command for adding the at least one data under a folder of the virtual container is detected; and
a third module configured to, when a user command associated with the file link item in the virtual container is detected, perform at least one function of the user command.

12. The electronic device of claim 11, wherein the virtual container is a floating window or a icon, and is displayed on a user interface of any folder.

13. The electronic device of claim 12, wherein the user command for adding the at least one data under any folder includes:
touching and dragging an icon representing the at least one data to the virtual container and then releasing the touch.

14. The electronic device of claim 11, further comprising: a forth module configured to insert the file link item containing the name and content of a at least one data into the content list when a user command for copying the at least one data under any folder is detected.

15. The electronic device of claim 14, further comprising:
a fifth module configured to display an icons of the at least one data for representing each file link item in the content list in a virtual container window of the virtual container when a user command for opening the virtual container is detected.

16. The electronic device of claim 15, further comprising:
a sixth module configured to search for the file link item of the at least one data represented by at least one icon from the content list, and perform an operation on the at least one data corresponding to the respective file link items when it is detected that the user determines to perform the predetermined operation on the one or more icons in the virtual container window, wherein the operation refers to one of the operations including sharing, copying, moving, transmitting and deleting files and the default operations carried out based on the file types.

17. The electronic device of claim 15, wherein a file type information is further stored in the file link item, and
when a user command for opening the virtual container is detected by the fifth module, the fourth module configured to display in the virtual container window the icons of the at least one data for representing each file link item in the content list according to in categories of the file types.

18. The electronic device of claim 17, wherein when a user command for opening the virtual container is detected by the fifth module, the fifth module is configured to display the menu item for selecting the operations performed on the files in the predetermined position in the virtual container window, and
when the sixth module detecting that the user determines to perform the operations on the at least one icon in the virtual container window, the sixth module is configured to receive the user selection for the operation performed on the at least one data represented by the at least one icon, search for the file link item of the represented by the at least one icon from the content list, and perform the operation selected by the user on the corresponding to the searched respective file link items.

19. The electronic device of claim 18, wherein,
when receiving the user selection for selecting one or more icons in the virtual container window and performing the file sharing operation on the at least one data represented by the icons, the sixth module is configured to perform a share operation on the at least one data corresponding to the searched respective file link items according to the predetermined sharing method;
when receiving the user selection for selecting at least one icon in the virtual container window and performing the file copying operation on the at least one data represented by the icons, the sixth module is configured to copy the at least one data corresponding to the searched respective file link items to the position designated by the user;
when receiving the user selection for selecting at least one icon in the virtual container window and performing the file moving operation on the at least one data represented by the icons, the sixth module is configured to move the at least one data corresponding to the searched respective file link items to the position designated by the user;
when receiving the user selection for selecting at least one icon in the virtual container window and performing the file deleting operation on the at least one data represented by the icons, the sixth module is configured to delete the corresponding to the searched respective file link items.

20. The electronic device of claim 16, further comprising:
a seventh module configured to delete the file link items of the at least one data represented by a designated icons from the content list when a user command for removing the designated icon in the virtual container window is detected.
